(19) United States
(12) Patent Application Publication
(10) Pub. No.: US 2008/0209756 A1
(43) Pub. Date: Sep. 4, 2008

(54) Fabric Treatment Composition

(76) Inventors: Karl Burgess, Wirral (GB); Uwe Hagemann, Vinhedo (BR)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/662,244

(22) PCT Filed: Aug. 1, 2005
(86) PCT No.: PCT/EP05/08382

§ 371 Date: Oct. 17, 2007

(30) Foreign Application Priority Data
Sep. 11, 2004 (GB) 0420202.4

(51) Int. Cl. F26B 7/00

(52) U.S. Cl. 34/389

(57) ABSTRACT

A heat activated fabric treatment composition comprises from 1 to 75 wt % of (a) a quaternary ammonium fabric softening system which comprises (i) a quaternary ammonium fabric softening material derived from a parent fatty acid or acyl compound having an average iodine value of from 0 to 19, and (ii) a quaternary ammonium fabric softening material derived from a parent fatty acid or acyl compound having an average iodine value of from 20 to 140, (b) from 5 to 60 wt % of a nonionic surfactant; and (c) from 5 to 70 wt % of water.

### FIELD OF THE INVENTION

The present invention relates to a fabric treatment composition. The invention particularly relates to a heat activated fabric treatment composition for use in a tumble dryer.

### BACKGROUND OF THE INVENTION

Heat activated fabric treatment compositions for use in an automatic tumble dryer are described in our co-pending applications, WO-A-03/087285 and WO-A-03/087286, and devices suitable for use in the treatment fabrics in a tumble dryer are disclosed in our co-pending applications, WO-A1-02/33160 and WO-A1-02/33161. The compositions of the present invention are particularly suitable for use in combination with such devices.

In order to optimise the delivery of the active material onto fabrics during the drying cycle, it is desirable to provide a fabric treatment composition which, at a temperature below the heating cycle temperature of the tumble dryer, remains substantially within a dispensing article and is capable of undergoing a transition during the heating cycle of a tumble dryer such that it can be dispensed from the dispensing article.

It is, therefore, desirable to provide a fabric treatment composition which is capable of undergoing such transitions without unacceptable instability. It is particularly desirable that the composition can undergo such a cycle repeatedly.

Effective delivery of such a fabric treatment composition requires the composition to be flowable at the delivery temperature (i.e. the heating temperature of the tumble dryer).

Accordingly, it is desirable to provide a heat activated fabric treatment composition which can be delivered as a liquid during the heating cycle of a tumble dryer from a dispensing device.

It is further desirable to provide a heat activated fabric treatment composition which can be stored in a dispensing device and which can undergo repeated cycles from a more viscous storage state to a less viscous dispensable state such that during the heating cycle of the tumble dryer at least part of the composition is delivered to fabrics and during the storage state does not leak from the device.

The problem of leakage becomes a significant risk when the ambient storage temperature is close to the melting temperature of the composition.

### OBJECTS OF THE INVENTION

The present invention seeks to address one or more of the above-mentioned problems and to provide one or more of the above mentioned benefits.

### STATEMENT OF INVENTION

Thus, according to the present invention there is provided a heat activated fabric treatment composition comprising:
(a) from 1 to 75 wt % of a quaternary ammonium fabric softening system which comprises:
   (i) a quaternary ammonium fabric softening material derived from a parent fatty acid or acyl compound having an average iodine value of from 0 to 19, and
   (ii) a quaternary ammonium fabric softening material derived from a parent fatty acid or acyl compound having an average iodine value of from 20 to 140
(b) from 5 to 60 wt % of a nonionic surfactant; and
(c) from 5 to 70 wt % of water.

According to a further aspect of the invention, there is provided a package comprising a composition as defined above within a dispensing device.

The invention further provides a method of conditioning fabrics in a tumble dryer comprising the steps of providing the heat activated fabric treatment composition in a dispensing device, locating the dispensing device on the internal panel of the door of the tumble dryer, inserting fabrics into the tumble dryer and operating the dryer to cause at least a part of the fabric treatment composition to be dispensed from the device onto the fabrics being dried so as to condition the fabrics.

### DETAILED DESCRIPTION OF THE INVENTION

In the context of the present invention, “heat activated” means that composition is suitable for use in a domestic tumble dryer, and preferably means that the composition is substantially solid at ambient temperature, i.e. 20° C., and undergoes a transition to a substantially liquid state at the heating temperature of a domestic tumble dryer.

Since the heating temperature of a domestic tumble dryer is typically within the range from about 40° C. to about 80° C., it is particularly preferred that the composition is substantially solid at temperatures below 30° C., more preferably below 32° C., most preferably below 35° C., e.g. below 37° C. and is substantially liquid, or at least mobile, at temperatures above 45° C., more preferably above 40° C., most preferably above 37° C. It is desirable that the composition is fully melted at temperatures above 50° C.

According to one method of defining the temperature at which the composition flows, it is desirable that the slip point of the composition is greater than 30° C. and less than 50° C., more preferably greater than 35° C. and less than 47° C., most preferably greater than 37° C. and less than 45° C.

The slip point of the composition is measured in accordance with British Standard BS 684 section 1.3 1991 ISO 6321:1991 (UK).

Product Form

In order to provide a fabric treatment composition capable of remaining substantially within a dispensing device during storage and being delivered to fabrics during the heating cycle of a tumble dryer, it is important that the composition has viscosity characteristics which allow the transition from a storage state to a dispensing state to occur at or about the heating temperature of the heat cycle. That is, the composition should preferably be a non-flowing, high viscosity product at ambient temperatures, e.g. a solid, soft solid or gel, and should become a low viscosity product, e.g. a liquid, at the heating temperatures of the tumble dryer.

Most preferably the composition is a “gel” at ambient temperature comprising a crystalline state forming a network to give the composition a non-flowing gel or gel-like consistency. At the heating temperature of the tumble dryer, the composition is most preferably a “sol” comprising a clear or isotropic solution.

Ideally, at the heating temperature the composition is a single phase or, if multi-phasic, the weight average particle size within the dispersed phase is smaller than a typical membrane pore size of a dispensing device. A typical membrane has a pore size in the range of 0.01-10 microns, though pore sizes outside this range may also be suitable. For instance, compressed foams and sinters may have larger pore sizes, e.g. up to 50 microns, or even higher.

The pore size should not be so small that dispensing becomes difficult and should not be so large pore sizes such that too much composition is released per cycle, thereby increasing the risk of staining.

Typically the composition will have a viscosity of above 375 mPa·s at a shear rate of 100s⁻¹ at ambient temperature, more preferably above 450. mPa·s, most preferably above 500 mPa·s, e.g. above 600 mPa·s. The viscosity of the composition at ambient temperature can be measured by first melting the composition (if necessary), transferring it to a viscometer cup and then letting it cool to room temperature with gentle shearing.

At the heating temperature of a domestic tumble dryer, the composition will typically have a viscosity of below 350 mPa·s at 100s⁻¹, more preferably below 300 mPa·s, most preferably below 250 mPa·s, e.g. below 200 mPa·s.

Measurements are made using a Haake Rotoviscometer RV20. cup and bob NV1.

In order to provide optimal anti-staining benefits together with improved delivery of the composition to fabrics and better cycling between the storage state and dispensing state, the carrier system for the active ingredient(s) preferably comprises a nonionic surfactant, water and optionally a solvent.

Nonionic Surfactant

The nonionic surfactant is present in order to improve control of the melting temperature of the composition or at least to affect the temperature at which the composition flows.

It can also be present for other purposes. For instance, it has also been found to impart anti-static benefits to treated fabrics.

Preferred nonionic surfactants are solid at ambient temperature so that, once deposited onto fabrics, they cause greater scattering light from the fabrics thereby reducing visibility of any product deposited onto the fabric.

Furthermore, the preferred nonionic surfactants have an HLB within the range 8 to 20, more preferably 10 to 20, as this significantly improves solubilisation of the active components (such as fabric softening agents which typically have a solubility of less than 1×10⁻³ wt % in water at 20° C.) in the water phase at the elevated temperatures of the heating cycle.

Suitable nonionic surfactants include addition products of ethylene oxide and/or propylene oxide with fatty alcohols, fatty acids and fatty amines.

Ideally, the nonionic surfactant comprises an-average degree of alkoxylation of from 8 to 40 alkoxy units per molecule, more preferably 10 to 30, even more preferably 11 to 25, e.g. 12 to 22 alkoxy units.

Any of the alkoxylated materials of the particular type described hereinafter can be used as the nonionic surfactant.

Suitable surfactants are substantially water soluble surfactants of the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms with coco and tallow or chain composition being most preferred.

In the general formula for the ethoxylated nonionic surfactant, Y is typically:

—O—, —C(O)—, —C(O)N(R)— or —C(O)N(R)R—

in which R has the meaning given above or can be hydrogen; and Z is preferably from 8 to 40, more preferably from 10 to 30, most preferably from 11 to 25, e.g. 12 to 22.

The degree of alkoxylation, Z denotes the average number of alkoxy groups per molecule.

The nonionic surfactant may be a polyol based surfactant such as sucrose mono-, di- and poly-esters. Examples of suitable sucrose esters include sucrose monooleates, sucrose monostearate or mixture thereof, poly glycerols, alkyl polyglucosides such as coco or stearyl monoglucosides and stearyl triglucoside and alkyl polyglycerols.

The above nonionic surfactants are useful in the present compositions alone or in combination, and the term “nonionic surfactant” encompasses mixed nonionic surface active agents.

Sucrose based surfactants are highly suitable because of their higher hydration state relative to other alkoxylates.

The nonionic surfactant is advantageously present at a level of from 5 to 60% by weight based on the total weight of the composition, more preferably from 10 to 50 wt %, most preferably from 15 to 45 wt %.

Water

The compositions of the invention comprise water and are preferably aqueous.

The water-based nature of the compositions of the present. invention is believed to help reduce staining and is unlike conventional tumble dryer sheets which are substantially non-aqueous.

Water is present at a level of from 5 to 70%, preferably from 10 to 60%, more preferably from 15 to 50%, e.g. from 25 to 45% by weight based on the total weight of the composition.

When deposited onto fibre during the drying cycle, any water is preferably present as a continuous phase which may partially evaporate and/or remain partially associated with the active ingredient(s).

An unexpected benefit of water-based compositions is that the amount of staining is less dependent on the amount of delivery of the composition per heating cycle of the tumble dryer.

Solvent

Optionally and advantageously, the compositions comprise a solvent for the quaternary ammonium softening materials. The solvent further optimises the viscosity and flow temperature characteristics of the composition. Additionally, the solvent may act as a humectant retarding the loss of water from the composition upon storage.

Preferably the solvent is semi-polar.

Suitable solvents include any which have a flash point above the heating temperature of a tumble dryer. Ideally the solvent is also odourless.

Commercially available examples include polyols, such as glycol ethers. The most preferred solvent is dipropylene glycol.

The solvent is preferably present at a level of from 1 to 25%, more preferably from 2 to 20%, most preferably from 3 to 10% by weight, based on the total weight of the composition.

In addition to the separately added solvent, a small amount of solvent may be present together with the quaternary ammonium material as commercially supplied. This is not included in the total amount of solvent.

Preferably the weight ratio of nonionic surfactant to solvent is from 1:1 to 15:1, more preferably from 3:2 to 12:1 most preferably from 3:1 to 10:1.

The combined amount of nonionic surfactant and optional, separately added solvent is preferably less than 65% by weight of the composition, more preferably less than 60%, most preferably less than 55%.

It is possible to replace all or part of the water with one or more solvents. In this case, a higher level of added solvent and lower level of water than described herein may be present in the composition.

Quaternary Ammonium Fabric Softening System

The composition comprises a mixed active system which includes at least two different quaternary ammonium fabric softening materials.

Both of the quaternary ammonium materials have two C₁₂₋₂₈ alkyl or alkenyl groups connected to the nitrogen head group.

In the first quaternary ammonium fabric softening material, (i), the two C₁₂₋₂₈ alkyl or alkenyl groups are derived from a parent fatty acid or acyl compound having an average iodine value of from 0 to 19, more preferably 0 to 15, even more preferably 0 to 10, most preferably 0 to 5, e.g. 0 to 3.

In the second quaternary ammonium fabric softening material, (ii), the two C₁₂₋₂₈ alkyl or alkenyl groups are derived from a parent fatty acid or acyl compound having an average iodine value of from 20 to 140, more preferably 20 to 110, even more preferably 25 to 100, most preferably 30 to 95, e.g. 40 to 95.

Preferably at least one of the alkyl or alkenyl groups are connected to the nitrogen head group via an ester link. More preferably each alkyl or alkenyl group is independently connected to the nitrogen head group via an ester link.

Preferably, the average chain length of the alkyl or alkenyl groups is at least C₁₄, more preferably at least C₁₆. Most preferably at least half of the chains have a length of C₁₈.

It is generally preferred that the alkyl or alkenyl chains are predominantly linear.

The first group of cationic fabric softening compounds which can be used for both materials (i) and (ii), provided the requirements of iodine value are satisfied, is represented by formula (I):

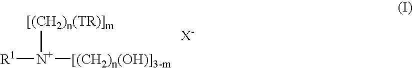

wherein each R is independently selected from a C₅₋₃₅ alkyl or alkenyl group, R¹ represents a C₁₋₄ alkyl, C₂₋₄ alkenyl or a C₁₋₄ hydroxyalkyl group,

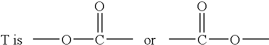

n is 0 or a number selected from 1 to 4, m is 1, 2 or 3 and denotes the number of moieties to which it relates that pend directly from the N atom, and X⁻ is an anionic group, such as halides or alkyl sulphates, e.g. chloride, methyl sulphate or ethyl sulphate.

It is to be understood that R must be selected so as to achieve the correct iodine value for materials (i) and (ii).

Especially preferred materials of this class are di-alkenyl esters of triethanol ammonium methyl sulphate.

A commercial example satisfying the definition of material (i) include Tetranyl AHT-1 (di-hardened oleic ester of triethanol ammonium methyl sulphate 80% active).

Commercial examples satisfying the definition of material (ii) include Tetranyl AT-1 (di-oleic ester of triethanol ammonium methyl sulphate 90% active), L5/90 (palm ester of triethanol ammonium methyl sulphate 90% active), all ex Kao, and Rewoquat WE15 (C₁₀-C₂₀ and C₁₆-C₁₈ unsaturated fatty acid reaction products with triethanolamine dimethyl sulphate quaternised 90% active), ex Witco Corporation.

The second group of cationic fabric softening compounds for use in the invention is represented by formula (II):

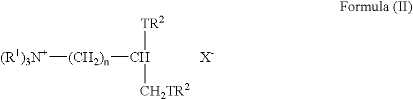

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above.

A third group of cationic fabric softening compounds for use in the invention is represented by formula (III):

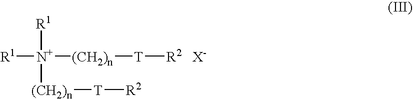

wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined above.

A fourth group of cationic fabric softening compounds for use in the invention is represented by formula (IV):

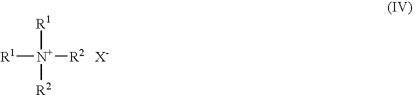

wherein each R¹ group is independently selected from C₁₋₄ alkyl, or C₂₋₄ alkenyl groups; and wherein each R² group is independently selected from C₈₋₂₈ alkyl or alkenyl groups; and X⁻ is as defined above.

For all the foregoing formulae, R² is be carefully selected so as to achieve the correct iodine values, as defined in the claims, for materials (i) and (ii).

The quaternary ammonium fabric softening active system is present in an amount of from 3 to 75% by weight (active ingredient) based on the total weight of the composition, preferably 4 to 60% by weight, more preferably 5 to 50% by weight, most preferably 10 to 45% by weight.

The weight ratio of material (i) to material (ii) is preferably from 5:1 to 1:15, more preferably from 2:1 to 1:12, even more preferably from 1:1 to 1:10, most preferably from 1:2 to 1:6, e.g. 1:3 to 1:5.

The phase transition temperature of the mixed actives as measured by DSC is preferably at least 40° C.

Iodine Value of the Parent Fatty Acyl group or Acid

In the context of the present invention, the iodine value of the parent fatty acyl compound or acid from which the fabric softening material formed, is defined as the number of grams of iodine which react with 100 grams of the compound.

The method for calculating the iodine value of a parent fatty acyl compound/acid comprises dissolving a prescribed amount (from 0.1-3 g) into about 15 ml chloroform. The dissolved parent fatty acyl compound/fatty acid is then reacted with 25 ml of iodine monochloride in acetic acid solution (0.1M). To this, 20 ml of 10% potassium iodide solution and about 150 ml deionised water is added. After addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acyl compound or fatty acid enables the iodine value to be calculated.

The nonionic surfactant is preferably present in an amount greater than the quaternary ammonium fabric softening system.

Preferably the nonionic surfactant is present in a weight excess, more preferably in a molar excess relative to the quaternary ammonium fabric softening system.

Ideally, the molar ratio of quaternary ammonium fabric softening system to nonionic surfactant is within the range from 2:1 to 1:25, more preferably from 1:1 to 1:15 most preferably from 1:1 to 1:7, e.g. 2:3 to 1:5.

Preferably the weight ratio of quaternary ammonium fabric softening system to nonionic surfactant is within the range from 2:1 to 1:100, more preferably from 3:2 to 1:75, most preferably from 1:1 to 1:20, e.g. 2:3 to 1:5.

Perfume

It is desirable that the compositions of the present invention also comprise one or more perfumes. Suitable perfume ingredients include those disclosed in “Perfume and Flavor Chemicals (Aroma Chemicals)”, by Steffen Arctander, published by the author in 1969, the contents of which are incorporated herein by reference.

The inventors have found that up to 10 wt % perfume can be incorporated in the compositions of the present invention without destabilising the composition. Such levels are significantly higher than those present in commercially available tumble dryer sheets. Accordingly, better perfume substantivity and longevity can be achieved from the present compositions than from traditional tumble dryer sheets.

Thus, it is desirable that the level of perfume is greater than 3 wt %, more preferably greater than 4 wt %, most preferably greater than 5 wt %, based on the total weight of the composition.

Fatty Component

The compositions of the present invention may comprise a fatty component such as a fatty acid and/or a fatty alcohol.

Suitable fatty acids/alcohols have a hydrocarbyl chain length of from 8 to 26 carbon atoms, more preferably 12 to 22, most preferably from 12 to 20 carbon atoms.

Preferred fatty acids include hardened tallow fatty acid (available under the tradename Pristerene, ex Uniqema).

Preferred fatty alcohols include hardened tallow alcohol (available under the tradenames Stenol and Hydrenol, ex Cognis and Laurex CS, ex Albright and Wilson) and behenyl alcohol, a C22 chain alcohol, available as Lanette 22 (ex Henkel).

The fatty acid and/or alcohol is preferably present in an amount of from 0.5% to 15% by weight based on the total weight of the composition. More preferably, the fatty component is present in an amount of from 1 to 10%, most preferably from 1.5 to 7% by weight.

Other Co-Active Ingredients

Other co-active ingredients for the fabric treatment active ingredient may also be incorporated in an amount from 0.01 to 20% by weight, more preferably 0.05 to 10%, based on the total weight of the composition. Preferred ingredients of this type include fatty esters, and fatty N-oxides.

Preferred fatty esters include fatty monoesters, such as glycerol monostearate. If GMS is present, then it is preferred that the level of GMS in the composition, is from 0.01 to 10 wt %, based on the total weight of the composition.

Polymeric Viscosity Control Agents

A polymeric viscosity control agent may also be present in the compositions of the invention. Suitable polymeric viscosity control agents include nonionic and cationic polymers, such as hydrophobically modified cellulose ethers (e.g. Natrosol Plus, ex Hercules) and cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Polymeric viscosity control agents are preferably present in an amount of from 0.01 to 5 wt %, more preferably 0.02 to 4 wt %, based on the total weight of the composition.

Other Optional Ingredients

The compositions may also contain one or more optional ingredients conventionally included in fabric conditioning compositions such as pH buffering agents, perfume, perfume carriers, fluorescers, colourants, antifoaming agents, antiredeposition agents, polyelectrolytes, enzymes, optical brightening agents, anti-shrinking agents, anti-wrinkle agents, anti-spotting agents, germicides, fungicides, anti-bacterial agents, lubricants, solvents, anti-corrosion agents, drape imparting agents, ironing aids and dyes.

### EXAMPLES

The invention will now be illustrated by the following non-limiting examples. Further modifications within the scope of the invention will be apparent to the person skilled in the art.

Samples of the invention are represented by a number. Comparative samples are represented by a letter.

All values are % by weight of the active ingredient unless stated otherwise.

The following compositions were prepared as follows. The nonionic surfactant and quaternary ammonium softening materials were co-melted with stirring at 60° C. Dipropylene glycol followed by the perfume was then added, with stirring throughout. Demineralised water was heated to about 45° C. to 50° C. and added. The resulting mixture was stirred at 150 r.p.m. until homogeneous.

TABLE 1

| Ingredient | Sample A | Sample 1 |
|---|---|---|
| Softener^{a} | 15.0^{a} | 12.0 |
| Softener^{b} | — | 3.0 |
| Nonionic Surfactant^{c} | 40.0 | 39.0 |
| Dipropylene glycol | 5.25 | 5.15 |
| Perfume | 5.0 | 5.0 |
| Water | to 100 | to 100 |

^{a}Stepantex VL85G, ex Stepan (85% active in 15% dipropylene glycol). A quaternary ammonium softening material based on triethanolamine. IV about 40.
^{b}Stepantex X2508, ex Stepan (85% active in 15% dipropylene glycol). A quaternary ammonium softening material based on triethanolamine. IV less than 2.
^{c}Genapol C200, ex Clariant, a Coco based Nonionic with an average of 20 ethoxylate groups

Assessment

A dispensing device—as described on page 16 line 26 to page 20 line 12 and shown in FIGS. 1, 3 and 4 of patent application WO-A-02/33161 having a membrane thickness of 160 μm, a membrane pore size of 0.2 μm and membrane area of 1080 mm²—was charged with 30 g of each of the samples.

The device was heated to a temperature of 60° C. for 2 to 3 hours until at least 80% of the front of the foam pad was visually “wetted” with the product (so as to simulate conditions in a typical tumble dryer). It was then allowed to cool and placed in an upright position. Control samples (100 g) were also placed into sealed containers.

The samples were stored at high temperatures for 3 days and visually assessed for physical state/leakage. The experiment was then repeated over 7 days.

The results are given in the following tables:

TABLE 2

| Storage | | Sample A (in |
|---|---|---|
| Temperature | | sealed |
| (° C.) | Sample A (in device) | container) |
| 45 | Significant dripping (within 3 hours) | liquid |
| 37 | Dripping (within 24 hours) | solid |
| 33 | Dripping (within 1-3 days) | solid |
| 28 | Slight dripping (within 3-4 days) | solid |

Surprisingly, even at temperatures where the comparative sample remained solid when stored in the sealed container, it suffered from leakage from the device.

TABLE 3

| Storage Temperature | |
|---|---|
| (° C.) | Sample 1 (stored in device) |
| 45 | Significant dripping (within 3 hours) |
| 37 | Slight dripping (within 2-3 days) |
| 33 | Trace dripping/moistness (within 4 days) |
| 28 | No dripping |

The results demonstrate that at temperatures below the typical operating temperature of a tumble dryer, the sample of the invention exhibited significantly better storage stability than the comparative sample.

1. A heat activated fabric treatment composition which is substantially solid at 20° C. and undergoes a transition to a substantially liquid state at a temperature in the range 40 to 80° C. comprising:
(a) from 1 to 75 wt % of a quaternary ammonium fabric softening system which comprises:
(i) a quaternary ammonium fabric-softening material having two C₁₂-C₂₈ alkyl or alkenyl groups connected to the nitrogen head group derived from a parent fatty acid or acyl compound having an average iodine value of from 0 to 19, and
(ii) a quaternary ammonium fabric softening material having two C₁₂-C₂₈ alkyl or alkenyl groups connected to the nitrogen head group derived from a parent fatty acid or acyl compound having an average iodine value of from 20 to 140
(b) from 5 to 60 wt % of a nonionic surfactant; and
(c) from 5 to 70 wt % of water.

2. A composition according to claim 1 in which the weight ratio of material (i) to material (ii) is from 5:1 to 1:15.

3. A composition according to claim 1 in which the weight ratio of material (i) to material (ii) is from 2:1 to 1:12.

4. A composition according to claim 1 in which the weight ratio of material (i) to material (ii) is from 1:1 to 1:10.

5. A composition according to claim 1 in which the weight ratio of material (i) to material (ii)is from 1:2 to 1:6.

6. A composition according to claim 1 in which the weight ratio of material (i) to material (ii) is from 1:3 to 1:5.

7. A package comprising a composition as defined in claim 1 within a dispensing device.

8. A method of conditioning fabrics in a tumble dryer comprising the steps of providing the heat activated fabric treatment composition according to claim 1 in a dispensing device, locating the dispensing device on the internal panel of the door of the tumble dryer, inserting fabrics into the tumble dryer and operating the dryer to cause at least a part of the fabric treatment composition to be dispensed from the device onto the fabrics being dried so as to condition the fabrics.
